(19) United States
(12) Patent Application Publication
(10) Pub. No.: US 2011/0285235 A1
(43) Pub. Date: Nov. 24, 2011

(54) Electro Magnetic Pulse Motor/Generator

(76) Inventors: Matthew Dale Weems, Jacksonville, TX (US); Roger Dale Weems, Jacksonville, TX (US)

(21) Appl. No.: 12/938,475

(22) Filed: Nov. 3, 2010

Related U.S. Application Data
(60) Provisional application No. 61/342,771, filed on Apr. 20, 2010.

(51) Int. Cl. H02K 21/16; H01R 39/60

(52) U.S. Cl. 310/156.01; 310/219

(57) ABSTRACT

An apparatus and method of providing output power from electrical pulse current in a highly efficient configuration. The input pulse current passes through a series of configured and wound input coils specifically positioned in an alternating manner in respect to wound and “tapped” output coils. Current is induced in the output coils in a highly efficient manner and can be output from the apparatus at each layer of winding, reducing resistance to induction. In an embodiment, the apparatus comprises a “power wheel”, a plurality of magnetic nodes spaced evenly over the outer circumference of said power wheel, each of said magnetic nodes having the same magnetic polarity facing radially outward from the center of said power wheel; an electro-magnetic generator, which electromagnetically causes said power wheel to rotate, with alternating layered windings of input coils and output coils such that said output coils are “tapped” at each layer of winding; and a means for switching, in which rotation of said power wheel causes pulse current to be applied to said input coils.

### CROSS-REFERENCES AND PRIORITY CLAIMS

The present application claims the benefit of Provisional U.S. Application No. 61/342,771, dated Apr. 20, 2010, entitled “Electro magnetic pulse motor/generator,” the disclosure of which is incorporated by reference.

### BACKGROUND

This invention relates to an apparatus and method of providing both mechanical and electrical power harnessed from electrical pulse current. Specifically, the apparatus relates to the use of an electric pulse motor and electro-magnetic generator to induce current in output coils as well as providing mechanical power through a spinning shaft.

The current invention utilizes electrical pulse current provided to power a drive shaft and induce a current in output coils. The electrical pulse current passes through a series of configured and wound input coils specifically positioned in an alternating manner in respect to wound and “tapped” output coils. Current is induced in the output coils in a highly efficient manner and can be output from the apparatus at each layer of winding, reducing resistance to induction.

Electrical motors generally require electrical input to power the motor, and output is linked to a spinning shaft to provide mechanical power. More efficient motors produce output close to the amount of input power. However, such motors require substantial input power to produce an efficient amount of output power. In addition, induction opposing resistance reduces output power; therefore, a need arises for an apparatus and process that produces electrical and mechanical power in a highly efficient configuration.

### SUMMARY

The current invention solves the need for an apparatus and process that produces electrical and mechanical power in a highly efficient configuration. The current invention comprises various embodiments for utilizing electrical pulse current to provide both mechanical and electrical power. Alternating layers of input and output coils are configured to induce an electrical current in the multiple “tapped” output coils. By design, this configuration maximizes induced electrical current while reducing induction opposing resistance. In an embodiment, the apparatus comprises a “power wheel”, a plurality of magnetic nodes spaced evenly over the outer circumference of said power wheel, each of said magnetic nodes having the same magnetic polarity facing radially outward from the center of said power wheel; an electro-magnetic generator, which electromagnetically causes said power wheel to rotate, with alternating layered windings of input coils and output coils such that said output coils are “tapped” at each layer of winding; and a means for switching, in which rotation of said power wheel causes pulse current to be applied to said input coils.

It is an object of the current invention to provide a source of mechanical power.

It is an object of the current invention to provide a source of electrical power by alternating windings of input and output wiring such that the output wirings are “tapped” at each layer of winding in an electromagnetic generator. The “tapped” windings terminate in an output that provides electrical power. “Pulse current” is supplied to the input wire.

It is an object of the current invention to provide mechanical power and electrical power, in which the electrical power is produced in a highly efficient configuration.

It is an object of the current invention to induce the greatest amount of current possible from an output coil due to specific winding configuration of input coils and output coils.

### DESCRIPTION OF THE DRAWINGS

These and other features, aspects and advantages of the present invention will become better understood with regard to the following description, appended claims, and accompanying drawings where:

FIG. 1 shows a side elevation view of an embodiment of the current invention in the “open position”;

FIG. 2 shows a cross-sectional view of an embodiment of the invention, illustrating a cut-away view of the electro-magnetic generator;

FIG. 3A shows a side elevation view of the embodiment of the invention in FIG. 1 illustrating the switching means in the “open position”;

FIG. 3B shows a side elevation view of the embodiment of the invention in FIG. 1 illustrating the switching means in the “closed position”;

FIG. 4 shows a front view of the embodiment of the invention in FIG. 1 illustrating the power wheel mounted on a single shaft passing through a side motor mount;

FIG. 5 shows a cross-sectional view of an embodiment of the invention, illustrating the wiring configuration of the input coils and “tapped” output coils, where said input coils and said output coils pass through barrier strips and full wave bridge rectifiers;

FIG. 6 illustrates a side elevation view of alternate embodiments of the current invention in which the power wheel may be constructed of various shapes;

FIG. 7A illustrates a side elevation view of an alternate embodiment of the current invention in which multiple electro-magnetic generators may be placed in several configurations in relation to the power wheel;

FIG. 7B illustrates a side elevation view of an alternate embodiment of the current invention in which several power wheels and electro-magnetic generators may be used;

FIG. 8 shows three graphs illustrating examples of waveforms of AC, DC, and pulse current with respect to time;

FIG. 9 shows a chart detailing the position and configuration of the magnetic nodes, power wheel, and switching state when the machine is in the “open position” or “closed position”;

FIG. 10 illustrates a circuit diagram of the embodiment of the invention in FIG. 1.

### DESCRIPTION

### Overview

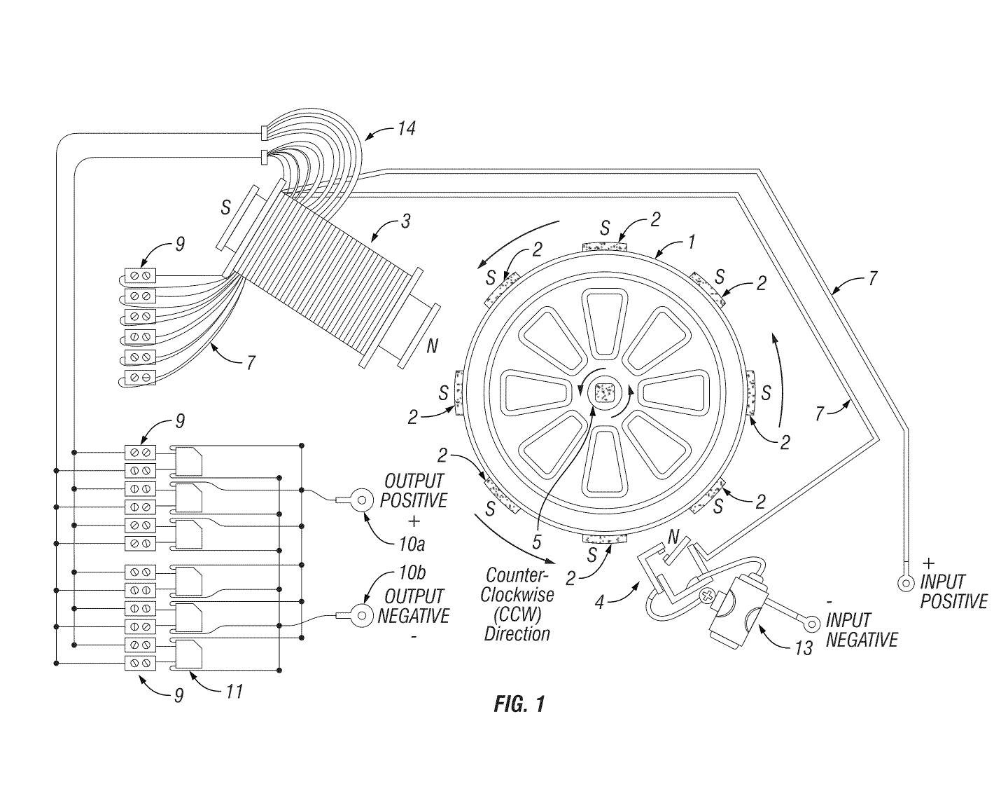

An embodiment of the current invention is shown in FIG. 1, the device comprises a “power wheel” 1, a plurality of magnetic nodes 2, spaced evenly over the outer circumference of said power wheel, each of said magnetic nodes having the same magnetic polarity facing radially outward from the center of said power wheel; an electro-magnetic generator 3, which electromagnetically causes said power wheel to rotate, with alternating layered windings of input coils and output coils such that said output coils are “tapped” at each layer of winding; and a means for switching 4, in which rotation of said power wheel causes pulse current to be applied to said input coils.

### Detailed Description of the Elements

As may be appreciated by the drawings, a “power wheel” 1, is substantially cylindrical in shape, fixedly attached to a rotatable shaft or axle 5, which may be attached to a separate motor as a power take-off (“P.T.O”). The power wheel contains a plurality of evenly spaced magnetic nodes 2, across the circumference of said power wheel. The said magnetic nodes have magnetic properties and are positioned in relation to each other across the circumference of said power wheel, with each magnetic node having the same polarity facing radially outward in relation to the center of said power wheel, as shown in FIGS. 1, 4, 6, 7A, and 7B.

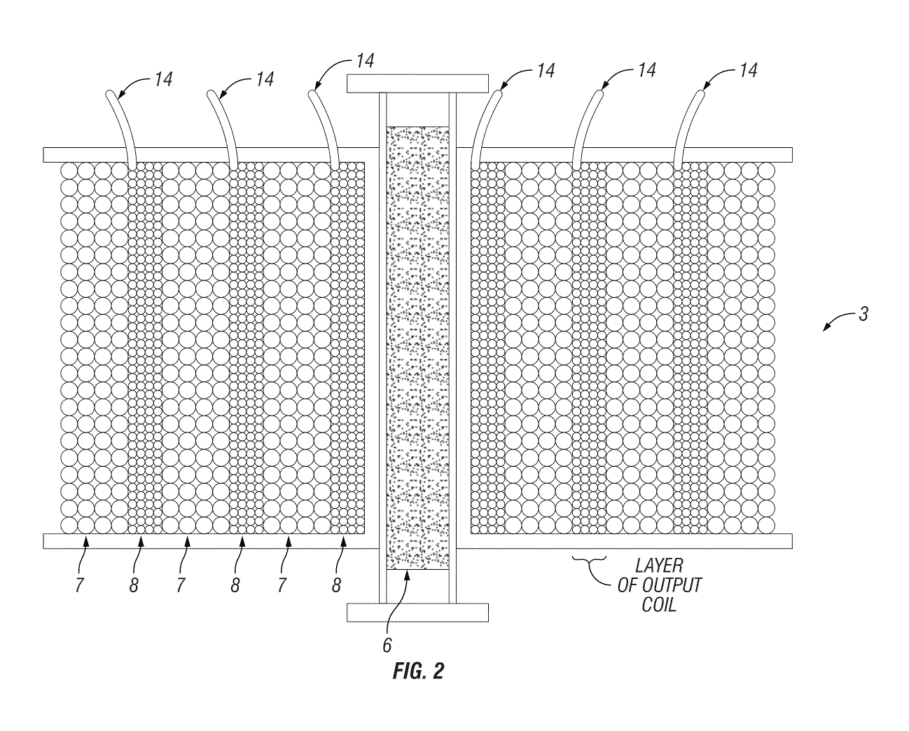

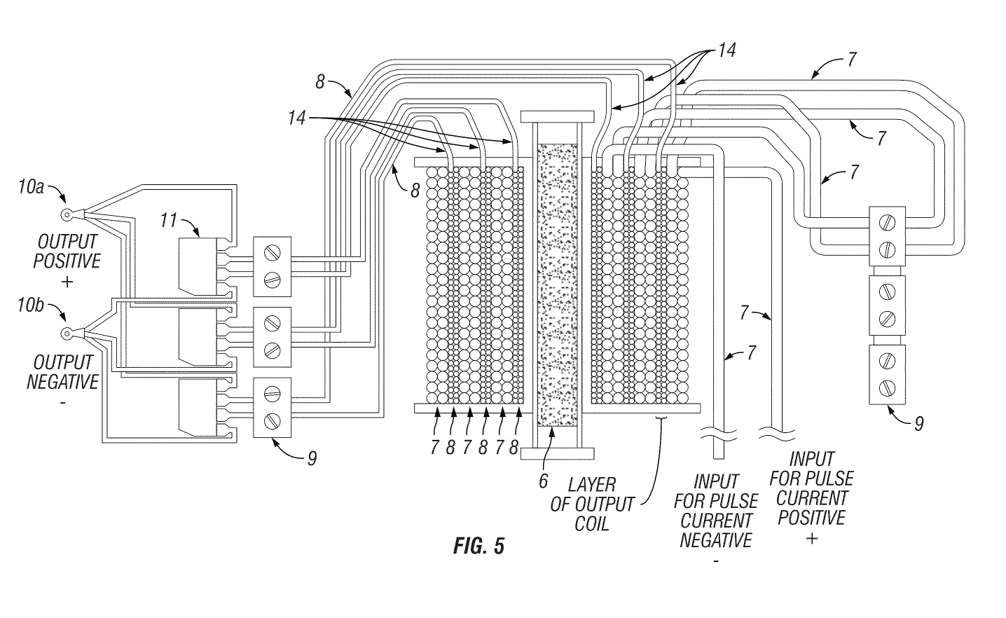

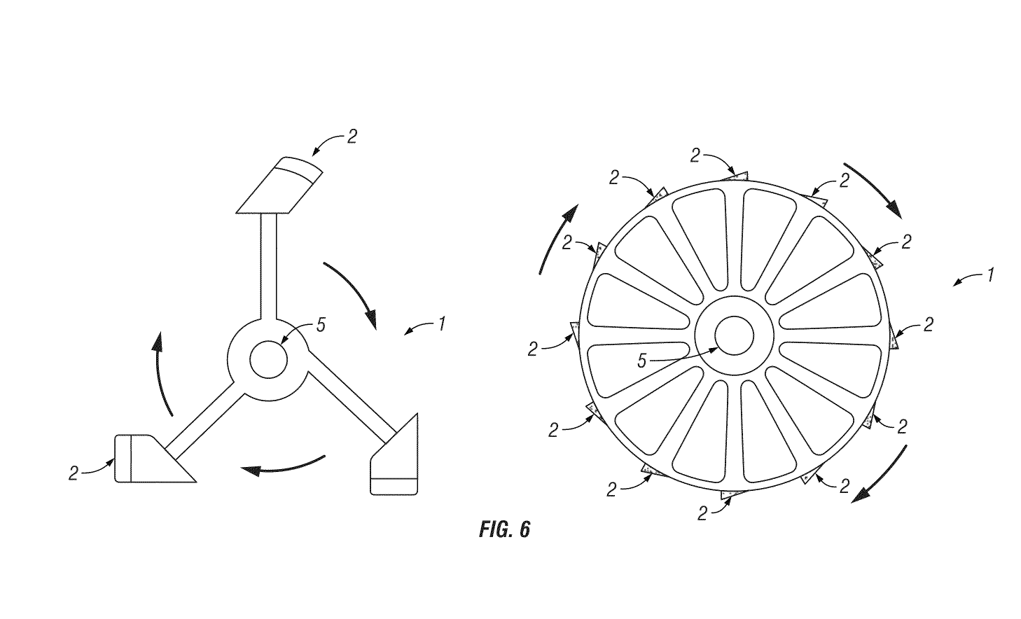

The electro-magnetic generator 3, is comprised of a solid metal core 6, wrapped in alternating layers of input coils 7, and output coils 8, as shown in FIGS. 2 and 5. An embodiment of the current invention uses a solid metal core substantially in the shape of a cylinder. Pulse current is supplied to the input coils, causing the electro-magnetic generator to behave as an electro-magnet.

The specific winding of said input coils 7, and said output coils 8, is unique to this invention and provides a highly efficient means of inducing current in the output coils. FIGS. 2 and 5 illustrate a cross-sectional view of said electro-magnetic generator 3, solid metal core 6, and wiring configuration of the input coils 7, and output coils 8. According to current invention, a length of one output coil is wrapped around the circumference of the solid metal core 6, such that each wrap is side-by-side. The two opposing ends of the output coil 8, extend outward from the solid metal core as output “taps” 14. Next, one end of the input coil 7, is attached to a switching means 4, and is wrapped around the circumference of the solid metal core on top of and in the same direction as the previously wound layer of output coil. The input coil traverses the circumference of the solid metal core and then passes away from the solid metal core, but does not terminate. A length of output coil 8, is wrapped around the circumference of the solid metal core 6, on top of the previously wrapped layer of input coil, and merges with other “tapped” output coils. The non-terminated input coil is then wrapped around the circumference of the solid metal core 6, on top of the previously wrapped layer of output coil. Layers of wound alternating input and output coils are stacked as shown in FIGS. 2 and 5. An electro-magnetic generator having n number of output layers will have n pairs of output taps, 14. After the layers of input coil 7, and output coil 8, are stacked, the non-terminated end of the input coil 7 is attached to the opposite position of the switching means 4. The terminated ends of each of the “tapped” output coils 14, are then contacted together such that the ends of each loop terminate in an opposing end of terminals of the electrical output 10a, 10b. Although the previous example detailed a situation where the output coils were wrapped first, other embodiments may be possible where the input coils are wrapped first. Either of the input coils or the output coils may be wrapped first, so long as the layers of input coils and output coils are alternating.

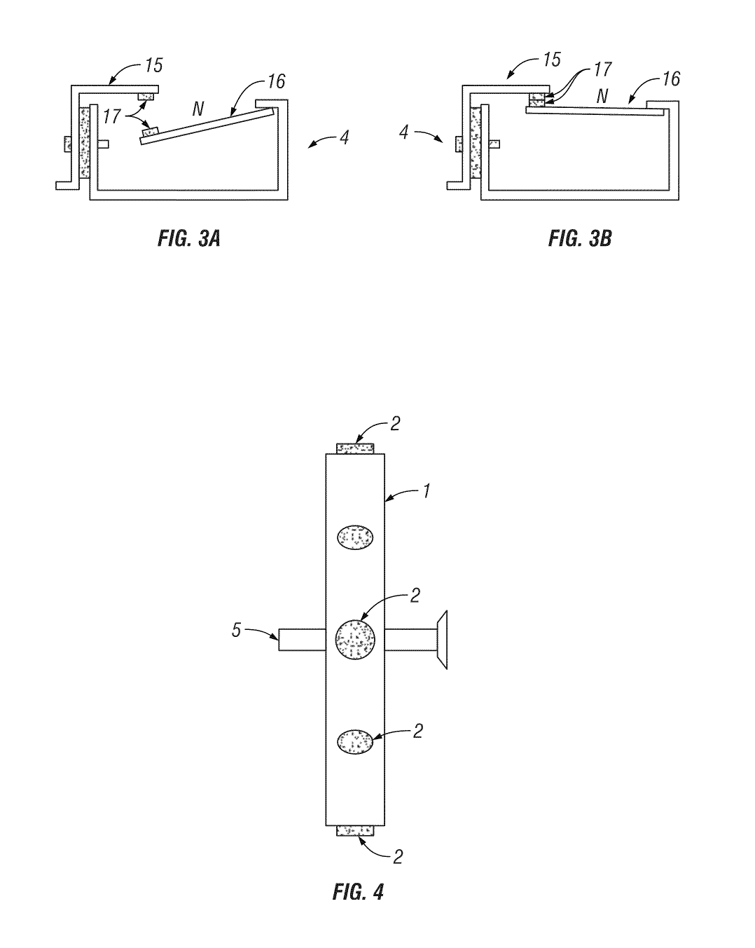

The switching means 4, provides a pulse current to be applied to the input coils 7. The switching means of the embodiment in FIGS. 1, 3A, and 3B is comprised of a magnetically operated contact switch 4, located near and approximately perpendicular to the power wheel 1. Said contact switch has an “open” and “closed” position. Opposing ends of input coil 7, are connected to each side of said contact switch.

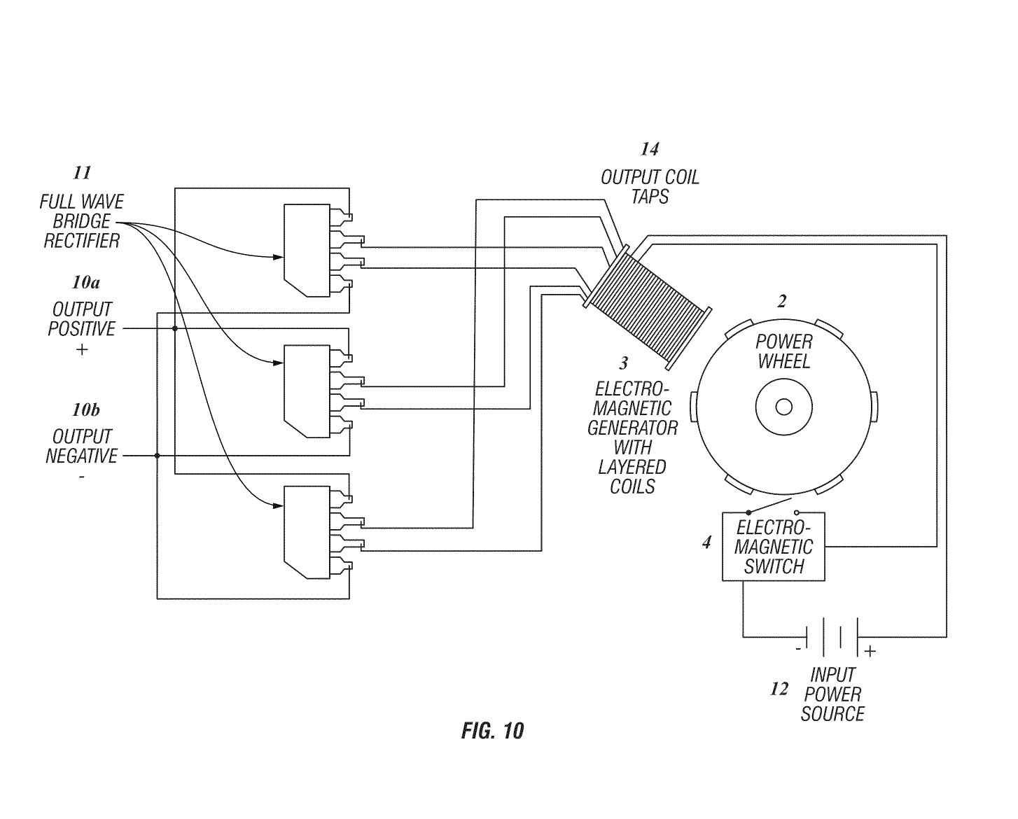

A power source 12, with opposing (positive and negative) ends is attached to each side of said power switch, as shown in FIG. 10. When said contact switch is closed, current is allowed to travel across the input coil, and causes the electro-magnetic generator 3, to function as an electro-magnet. The term “position” as it is used in this invention; refers to the open or closed state of the switching means, at a time t. According to the embodiment in FIGS. 1, 3A, and 3B, the switch will be in the “closed position” when one of said magnetic nodes 2, passes directly over said contact switch 4.

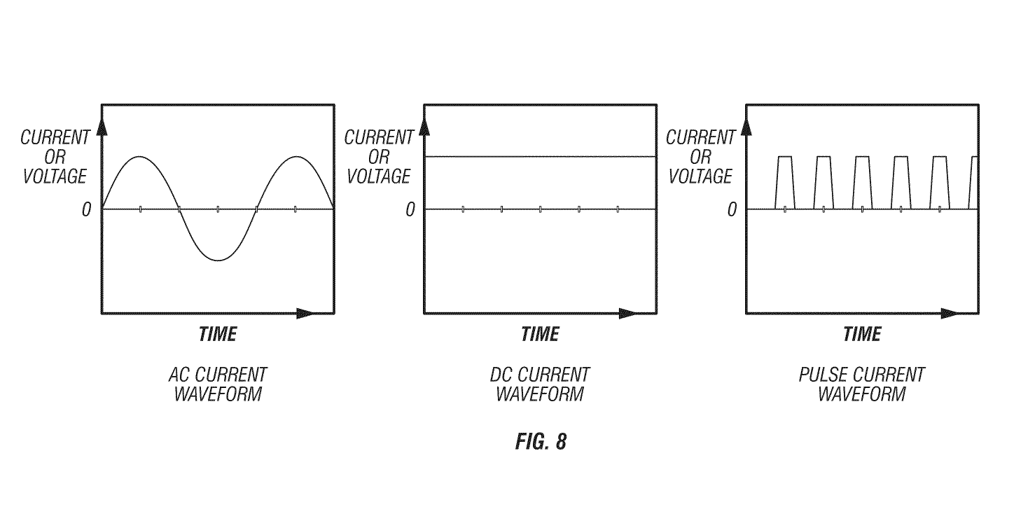

The current passing through the input coils is referred to as “pulse current.” A current is said to “pulse” when current rises from 0 amps to a specific amperage, and then back to 0 amps in a very short amount of time. An example of pulse current would exist over a given medium if a current rises from 0 amps to 10 amps, stayed at 10 amps for 100 ms, then falls back to 0 amps. The current invention uses a motor that causes pulse current to be passed over the input coils. An illustration of the waveform of pulse current with respect to time is shown in FIG. 8.

### How the Invention is Used

Pulse current passes over the input coils when the device is in the “closed position.” The waveform of said pulse current resembles a discrete function, as shown in FIG. 8. The device has numerous uses including providing both electrical and mechanical power. The shaft may serve as a drive-train or PTO for another mechanical device. Additionally, the output terminals may be attached to an external source or charger for power supply to another electrical device.

In the preferred embodiment of the invention, DC current is supplied to the input coils. The configuration of the coils results in pulse AC current induced in the output coils. The termination leads from the “tapped” output coils may be passed through a full wave bridge rectifier, resulting in an output of DC current.

### Specific Embodiments and Examples

An example of an embodiment of the current invention is set forth in the FIGS. 1, 3A, 3B, and 5, and is further described as the preferred design and best mode of carrying out the invention. The power wheel 1, is a rotary drum cylinder made of resilient material such as hard plastic, which is attached to a solid metal shaft 5, at its center. It is preferable that the power wheel is constructed of non-ferromagnetic material. Said power wheel is attached to a flat and solid planar surface, which allows the power wheel to freely spin parallel to said planar surface. A plurality of magnetic nodes 2, are attached to the outer surface of said power wheel. Said magnetic nodes are constructed of a ferromagnetic material such as neodymium, and are arranged such that the South poles of said magnetic nodes are facing radially outward from the center of the power wheel.

The solid metal core 6, is comprised of a cylindrical shaft of steel. The metal core is encompassed by a cylinder constructed of hard plastic. The cylinder is then placed longitudinally lengthwise into a larger cylinder with extending edges. Said extending edges of the larger cylinder are attached to the previously mentioned flat planar surface, such that both cylinders extend longitudinally parallel to said flat planar surface. In the preferred embodiment, the cylindrical shaft of ferromagnetic material may be pushed closer to the power wheel. Additionally, the entire electro-magnetic generator 3, may be allowed to pivot parallel to the flat planar surface. Pivoting the electromagnetic generator closer or further away from the power wheel increases or decreases both the angular speed of rotation of the power wheel and the output power of the device.

A layer of output coil 8, is coiled around the cylinder encompassing the solid metal core 6. Both ends of said output coil 14, are then passed through a barrier strip 9, for organizational purposes. One lead of input coil 7, is attached near the switching means, 4. Said input coil is then wrapped around the layer of previously wrapped output coil. and passed through a barrier strip 9, for organizational purposes. Layers of input coil and output coils are wound in this alternating configuration. The leads of said output coils 14, are passed through a full bridge wave rectifier, 11. Two groups of tapped “leads” are connected to produce two terminal points (positive and negative) 10a, 10b. In the preferred embodiment, the cross-sectional diameter of the output coils 8, is less than that of the cross-sectional diameter of the input coils 7, and implement 36 Gauge enamel coated wire. In the preferred embodiment, the input coils implement 22-24 Gauge enamel coated wire.

In the preferred embodiment, output coil 8, is first wound around the larger cylinder side-by-side until reaching the end of the available surface area of the larger cylinder. The wire is then wrapped side-by-side in the opposite direction until reaching the end of the available surface area of the larger cylinder, such that the two leads of the individual output coil are positioned at the same end of the larger cylinder. This forms the first “layer” of output coil winding, with one pair of “tapped” leads, 14. The input wire 7, is wrapped around the previously wrapped “layer” in the same configuration, its leads extending through a barrier strip 9, for organizational purposes. When winding is complete, the two leads of input coil extend outward from the electro-magnetic generator, 3. The individual “tapped” output leads 14, pass through a barrier strip 9, and through a full wave bridge rectifier, 11. Several layers of alternating output coils and input coils are used.

In the preferred embodiment, the switching means 4, comprises a mechanical switch such that the switch has an upper arm 15, a lower arm 16, and a contact point 17, on each arm. The contact point is the point where the two arms meet. Each arm does not make contact in its resting position (“open position”). Said lower arm 16, is constructed of ferromagnetic material. As said magnetic node 2, passes over the contact switch, the lower arm 16, is magnetically attracted and moves toward said magnetic node. The contact point 17, of both arms meet and causes the switch to be in the “closed position.” Electric current then passes through the input coil 7, and causes the electro-magnetic generator 3, to repel the magnetic node 2, away, thereby causing the power wheel 1, to spin in a counter-clockwise direction. One lead of input coil is connected to the lower arm. The other lead of input coil extends away and forms a terminal for power input. An electrical lead wire extends away from the upper arm and connects to one side of an electrical condenser 13. Another lead wire extends away from the lower arm and connects to the other side of said electrical condenser.

The preferred embodiment uses an electrical generator 12, as electrical input using DC current. The negative input lead from the generator is connected to the electrical condenser 13. The positive input lead from the electrical generator 12, is connected to the extending input coil. Pulse current causes current to be induced in the output coils.

In the preferred embodiment, tests have shown that a greater number of layered windings and magnetic nodes produce greater angular speed in the power wheel. Greater angular speed of the power wheel causes the current to pulse at a faster rate. Faster pulse current generally results in greater power output.

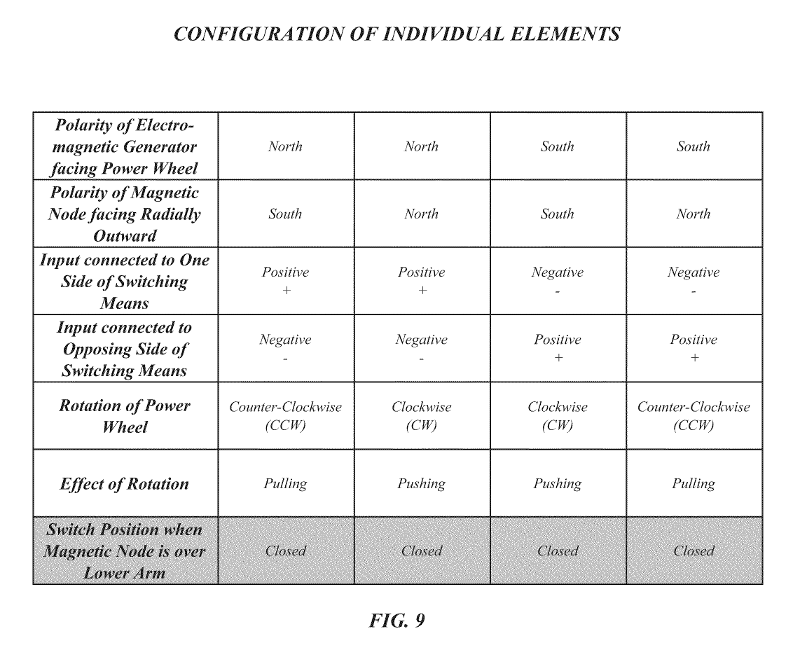

Different configurations of the magnetic polarity of magnetic nodes and placement of the power inputs cause differing movement of the power wheel. In the preferred embodiment, the South poles of the individual magnetic nodes are facing radially outward from the center of the power wheel. When the negative input is attached to the electrical condenser, and positive input is attached to the input coil lead, the power wheel rotates in a counter-clockwise direction. This effect is referred to as “pulling”, as the electro-magnetic generator behaves as if the North pole were facing the power wheel. Conversely, “pushing” the power wheel may be achieved by connecting positive input to the electrical condenser and negative input to the extending input lead. A reversal of the polarity of the individual poles of the magnetic nodes may reverse the direction of movement of the power wheel. Tests have shown that “pulling” is a more effective method of power generation than “pushing.” FIG. 9 illustrates the configurations of individual elements, the respective movements of the power wheel, and the switching state.

### Alternatives

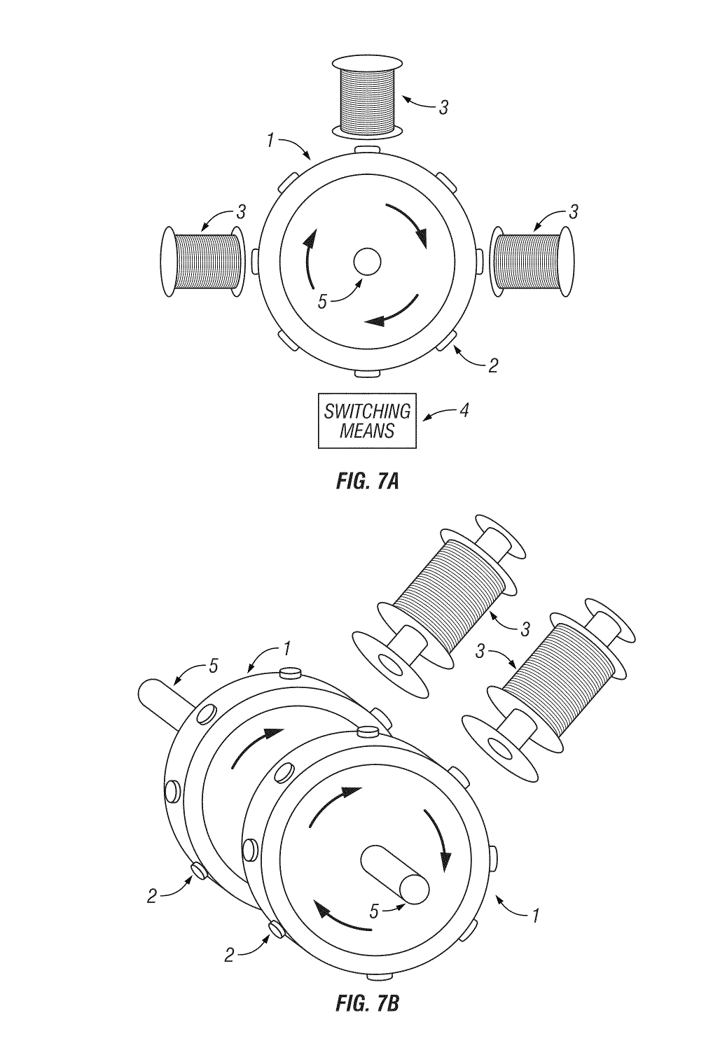

Although the present invention has been described in considerable detail with reference to certain preferred versions thereof, other versions are possible. For example, several power wheels may be aligned side-by-side to produce additional mechanical and electrical power, as illustrated in FIG. 7B. In this configuration, the input coils of each individual electro-magnetic generator are connected. Test results have shown that connecting the input coils of multiple electro-magnetic generators in parallel may produce greater results as opposed to connecting the input coils of multiple electro-magnetic generators in series.

Another embodiment involves using multiple electro-magnetic generators, positioned over the same power wheel, as illustrated in FIG. 7A. In this embodiment, pulse current is supplied to the input coils of each electro-magnetic generator at the same time, causing greater electro-magnetic “pull” or “push” of the power wheel.

Combining the previous two embodiments of multiple power wheels and multiple electro-magnetic generators is also contemplated by the current invention. For example, several power wheels may be aligned side-by-side. Each power wheel may have multiple electro-magnetic generators. As previously mentioned, each set of electro-magnetic generators corresponding to a power wheel may be connected either in series or in parallel. Tests have shown wiring the input coils of each set of electro-magnetic generators in parallel produces greater output.

Additionally, the power wheel may be constructed of various shapes, as illustrated in FIG. 6. For example, a series of extending arms may extend radially outward from the center of said power wheel, providing a contact point for an individual magnetic node.

The switching means may take numerous forms. It is contemplated that the switching means of the current invention operates as the functional equivalent of a simple electric switch, in which said switch is in a closed position when in proximity to an electromagnetic field. Examples may include circuit or logic design, a Hall Effect Switch, a Reed Switch, or other form of mechanically implemented switch, which changes the switching state by introduction of an electromagnetic field. Additionally, the state of the switch may be changed by constructing the lower arm of a magnetic material. For example, in the preferred embodiment previously mentioned, the polarity of the lower arm closest to the power wheel could be of North pole polarity. Positioning an individual magnetic node over the lower arm causes the switch to be “closed.” If the polarity of the lower arm closest to the power wheel is South pole polarity, then the switch would be “open” when a magnetic node passes over it.

The preferred embodiment includes the use of an electrical condenser attached to the switching means. Although included by way of example, an electrical condenser is not necessary for operation. For example, both of the electrical inputs could be connected to either side of the switching means. FIG. 10 illustrates the circuit diagram of the invention without the use of an electrical condenser.

The current invention encompasses design functions which maximize the amount of induced current in the output coils. Variations of this design may be implemented, such as placing numerous electro-magnetic generators in different positions in relation to the outer circumference of the power wheel. Therefore, the spirit and scope of the appended claims should not be limited to the descriptions of the preferred versions herein.

Any element in a claim that does not explicitly state “means for” performing a specified function, or “step for” performing a specific function, is not to be interpreted as a “means” or “step” clause as specified in 35 U.S.C. §112, ¶ 6. In particular, the use of “step of” in the claims herein is not intended to invoke the provisions of 35 U.S.C. §112, ¶ 6.

What is claimed is:

1. A motor-generator machine comprising:
a.) a power wheel;
b.) a plurality of magnetic nodes spaced evenly over the outer circumference of said power wheel, each of said magnetic nodes having the same magnetic polarity facing radially outward from the center of said power wheel;
c.) an electro-magnetic generator, which electromagnetically causes said power wheel to rotate, with alternating layered windings of input coils and output coils such that said output coils are “tapped” at each layer of winding; and
d.) a means for switching, in which rotation of said power wheel causes pulse current to be applied to said input coils.

2. The motor-generator of claim 1, wherein said power wheel is a rotary drum, substantially cylindrical in shape, fixedly attached to a rotatable axle.

3. The motor-generator of claim 1, wherein said alternating layers of input coils and tapped output coils are wrapped around a solid metal core.

4. The motor-generator of claim 1, wherein the cross-sectional diameter of said output coils are less than the cross-sectional diameter of said input coils.

5. The motor-generator of claim 1, wherein said input coils are constructed of about Gauge 22-24 enamel coated wire and said output coils are constructed of Gauge 36 enamel coated wire.

6. The motor-generator of claim 1, wherein the terminating leads of said output coils are passed through a full wave bridge rectifier and form output power terminals according to the current invention.

7. The motor-generator of claim 1, wherein said switching means is a magnetically operated contact switch, said magnetically operated contact switch comprised of an upper arm and a lower arm in which rotation of said power wheel causes said magnetically operated contact switch to oscillate between open and closed position.

8. The motor-generator of claim 7, wherein said magnetically operated contact switch is attached to an electrical condenser in which one end of said input coils is attached to said electrical condenser, one end of a power source is connected to said electrical condenser, and one end of said power source is connected to an opposing end of said input coil.

9. The motor-generator of claim 1, wherein said switching means is a Hall Effect Switch.

10. The motor-generator of claim 1, wherein said switching means is a Reed Switch.

11. The motor-generator of claim 1, wherein the introduction of an external power source causes said power wheel to rotate and pulse current to be introduced to said input coils.

12. The motor-generator of claim 11, wherein said external power source is DC current.

13. The motor-generator of claim 1, wherein said motor-generator outputs only mechanical power.

14. The motor-generator of claim 1, wherein said motor-generator outputs only electrical power.

15. The motor-generator of claim 1, wherein said motor-generator outputs mechanical power and electrical power.

16. The motor-generator of claim 1, wherein more than one electro-magnetic generators are used.

17. The motor-generator of claim 16, wherein said electro-magnetic generators are connected in parallel.

18. The motor-generator of claim 16, wherein said electro-magnetic generators are connected in series.

19. The motor-generator of claim 1, wherein more than one power wheel are used.

20. The motor-generator of claim 1, where said power wheel is comprised of a plurality of arm members extending radially outward form the center of said power wheel, each of said arm members providing a contact point for one of said magnetic nodes.

21. An electro-magnetic generator comprised of alternating layered windings of input coils and output coils such that said output coils are “tapped” at each layer of winding, whereby said input coils are connected to a source of pulse current.

22. The electro-magnetic generator of claim 21, wherein said input coils and said output coils are wrapped around a solid metal core.

23. The electro-magnetic-generator of claim 21, wherein the cross-sectional diameter of said output coils are less than the cross-sectional diameter of said input coils.

24. The electro-magnetic generator of claim 21, wherein the terminating leads of said output coils pass through a full wave bridge rectifier and form output power terminals according to the current invention.

25. A method of producing output power by connecting alternating layered windings of input coils and output coils, wherein said output coils are “tapped” at each layer of winding and said input coils are connected to pulsed input current according to the current invention.

26. The method of producing output power of claim 25 further including the step of passing said output coils through a full wave bridge rectifier.
